(19) United States
(12) Patent Application Publication
(10) Pub. No.: US 2016/0060538 A1
(43) Pub. Date: Mar. 3, 2016

(54) METHODS AND APPARATUSES FOR PROCESSING BIORENEWABLE FEEDSTOCKS WITH REDUCED EXTERNAL SULFIDING AGENT INPUT

(71) Applicant: UOP LLC, Des Plaines, IL (US)

(72) Inventors: Clint Vericker, Rantoul, IL (US); Nicholas Ficht, Elmhurst, IL (US)

(21) Appl. No.: 14/472,725

(22) Filed: Aug. 29, 2014

(51) Int. Cl. C10G 3/00; C10L 1/04; B01J 19/24; C10G 67/02; C10G 63/02; C10G 69/08; C10G 45/12

(52) U.S. Cl. CPC C10G 3/49; C10G 69/08; C10L 1/04; C10G 45/12; C10G 67/02; C10G 63/02; B01J 19/245; B01J 19/24; C10L 2200/0484; C10L 2290/24; B01J 2219/24

(57) ABSTRACT

Methods and apparatuses for processing biorenewable feedstocks are disclosed. In accordance with one exemplary embodiment, a method for processing a biorenewable feedstock includes the steps of combining an untreated, diesel boiling range petroleum distillate feedstock comprising sulfur with the biorenewable feedstock to form a combined feedstock and contacting the combined feedstock with a deoxygenation catalyst in the presence of hydrogen gas to form a deoxygenated, biorenewable product.

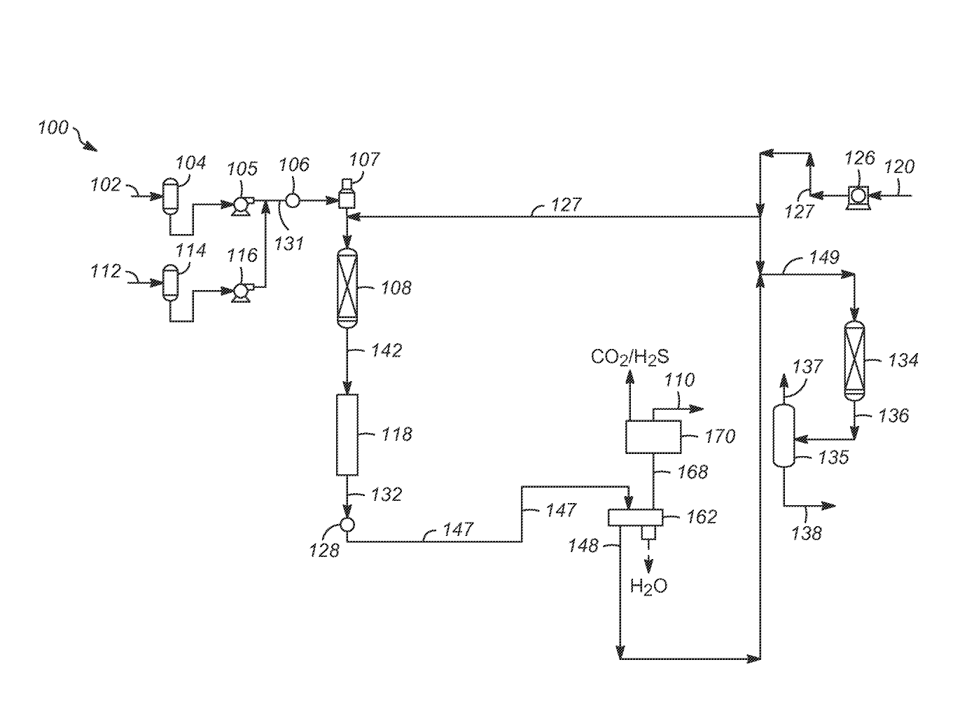

### TECHNICAL FIELD

The present disclosure generally relates to methods and apparatuses for producing renewable fuels and chemicals from biorenewable sources, and more particularly relates to methods and apparatuses for processing biorenewable feedstocks while reducing or eliminating the input of an external sulfiding agent.

### DESCRIPTION OF RELATED ART

As the worldwide demand for fuel increases, there is growing interest in sources other than crude oil for producing diesel fuel. One source of interest is biorenewable sources, such as vegetable oils and animal fats. A conventional catalytic hydroprocessing process known for converting such biorenewable feedstocks into biorenewable or “green” diesel fuels may be used as a substitute for the conventional processing of crude oil to produce diesel fuel. As a highly exothermic process, biorenewable hydroprocessing also supports the possible co-production of propane and other light hydrocarbons, as well as naphtha or green jet fuel. As used herein, the terms “green diesel fuel” and “green jet fuel” refer to fuel produced from biorenewable sources, in contrast to those produced from crude oil.

To produce the green diesel fuel, biorenewable feedstock is combined with hydrogen, brought to reaction temperature, and is then sent to a reactor where the biorenewable feedstock is converted in the presence of a deoxygenation catalyst into a reaction product. The reaction product includes a liquid fraction and a gaseous fraction. The liquid fraction includes a hydrocarbon fraction containing n-paraffins. Although this hydrocarbon fraction is useful as a diesel fuel, it has poor cold flow properties. To improve the cold flow properties of the hydrocarbon fraction, the liquid fraction may be contacted with an isomerization catalyst under isomerization conditions to at least partially isomerize the n-paraffins to iso-paraffins. Regardless of whether isomerization is carried out, the liquid fraction is separated from the gaseous fraction and sent to a fractionation unit to produce the green diesel fuel.

The deoxygenation catalyst used in the process must remain sulfided to maintain its performance, but the water formed during deoxygenation tends to strip sulfur from the catalyst. Separate catalyst sulfiding systems providing an external source of a sulfiding agent (usually H₂S) are typically required in prior art systems to maintain the deoxygenation catalyst in its sulfided form. Unfortunately, H₂S is an expensive additive and the separate systems increase processing complexity and cost.

Accordingly, it is desirable to provide methods and apparatuses for processing a biorenewable feedstock to produce a hydrocarbon fraction that will provide a green diesel fuel and maintain the deoxygenation catalyst in a sulfided form that reduces or eliminates the amount of external sulfiding agent input. Furthermore, other desirable features and characteristics of the presently disclosed embodiments will become apparent from the subsequent detailed description and the appended claims, taken in conjunction with the accompanying drawings and this background.

### BRIEF SUMMARY

Methods and apparatuses for processing biorenewable feedstocks are disclosed. In accordance with one exemplary embodiment, a method for processing a biorenewable feedstock includes the steps of combining an untreated, diesel boiling range petroleum distillate feedstock comprising sulfur with the biorenewable feedstock to form a combined feedstock and contacting the combined feedstock with a deoxygenation catalyst in the presence of hydrogen gas to form a deoxygenated, biorenewable product.

In accordance with another exemplary embodiment, an apparatus for processing a biorenewable feedstock includes a first feedstock source comprising an untreated, diesel boiling range petroleum distillate feedstock comprising sulfur and a second feedstock source comprising the biorenewable feedstock, a combining means that combines the untreated, diesel boiling range petroleum distillate feedstock with the biorenewable feedstock to form a combined feedstock, and a deoxygenation reactor that contacts the combined feedstock with a deoxygenation catalyst in the presence of hydrogen gas to form a deoxygenated, biorenewable product.

In accordance with yet another exemplary embodiment, a process for producing a biorenewable diesel boiling range product includes the steps of combining an untreated, diesel boiling range petroleum distillate feedstock comprising sulfur and nitrogen with the biorenewable feedstock comprising free fatty acids and tri-glycerides to form a combined feedstock comprising at least about 150 wt. ppm sulfur, purifying the combined feedstock in a guard bed to form a purified, combined feedstock, and contacting the purified, combined feedstock with a deoxygenation catalyst in a single-pass or once-through deoxygenation reactor in the presence of hydrogen gas to form a deoxygenated, biorenewable product. The process may include the steps of contacting the deoxygenated, biorenewable product with an isomerization catalyst in an isomerization reactor in the presence of hydrogen gas to form an isomerized, biorenewable product.

### BRIEF DESCRIPTION OF THE DRAWING

The present disclosure will hereinafter be described in conjunction with the following drawing FIGURE, wherein like numerals denote like elements, and wherein:

The FIGURE is a flow diagram of a method implemented on an apparatus for processing a biorenewable feedstock according to exemplary embodiments of the present disclosure.

### DETAILED DESCRIPTION

The following detailed description is merely exemplary in nature and is not intended to limit the methods and apparatuses claimed herein. Furthermore, there is no intention to be bound by any theory presented in the preceding background or the following detailed description.

Various exemplary embodiments described herein are directed to methods and apparatuses for co-processing a biorenewable feedstock and an untreated, diesel boiling range petroleum distillate feedstock to produce a hydrocarbon fraction useful as a green diesel fuel. As used herein, the term “diesel boiling range” refers to hydrocarbons boiling in the range of from about 132 and about 399° C. using the True Boiling Point distillation method. The term “True Boiling Point” (TBP) means a test method for determining the boiling point of a material that corresponds to ASTM D2892 for the production of a liquefied gas, distillate fractions, and residuum of standardized quality on which analytical data can be obtained. The term “untreated” refers to a feedstock that has not been subjected to any desulfurization or denitrogenation processes, such as processing in a hydrotreating reactor for the removal of sulfur and/or nitrogen species.

In an exemplary embodiment, the deoxygenation catalyst is maintained in a sulfided form by combining the biorenewable feedstock and the untreated, diesel boiling range petroleum distillate feedstock into a combined feed stream, and feeding the combined feed stream to the deoxygenation reactor. The untreated, diesel boiling range petroleum distillate feedstock is combined with the biorenewable feedstock in an amount sufficient to maintain a minimum amount of sulfur species, as will be described in greater detail below. The use of the combined feed stock reduces or eliminates the need for additional sulfiding agent input to the processing apparatus, and further has the benefit of reducing or eliminating the need for a recycle stream in connection with the deoxygenation reactor, which reduces costs and increases throughput.

As shown in the FIGURE, in accordance with an exemplary embodiment, a method 10 for processing a biorenewable feedstock and an untreated, diesel boiling range petroleum distillate feedstock includes providing an untreated, diesel boiling range petroleum distillate feedstock 102. The untreated, diesel boiling range petroleum distillate feedstock may be commercially available or available elsewhere in the same refinery used to process biorenewable feedstock into green diesel fuel and other possible co-products. For example, untreated, diesel boiling range petroleum distillates are often recovered from crude oil fractionation or distillation operations, and optionally following one or more hydrocarbon conversion reactions. Untreated, diesel boiling range petroleum distillate feedstocks suitable for use according to exemplary embodiments contain organic sulfur compounds. The sulfur may be substantially present in the form of organic sulfur compounds such as alkylbenzothiophenes

Referring to exemplary apparatus 100 illustrated in the FIGURE, a feed transfer pump (not shown) brings the untreated, diesel boiling range petroleum distillate feedstock 102 into a distillate feed surge drum 104. A feed transfer pump (not shown) brings fresh biorenewable feedstock 112 into a feed surge drum 114 via a feed filter (not shown), where particulate matter is removed. Further, the fresh biorenewable feedstock 112 flows from the feed surge drum 114 via a charge pump 116. The biorenewable feedstock may be formed from a variety of different biorenewable feedstocks that may be converted into green diesel fuel and co-products. These include conventional vegetable oils, animal fats, and second generation oils such as jatropha, camelina, and algal oils, among others well-known in the art. The biorenewable feedstocks that can be used include any of those that include primarily triglycerides and Free Fatty Acids (FFA). These compounds contain n-paraffin chains having 10-22 carbon atoms, in the triglycerides or FFAs can be mono-, di-, or poly-unsaturated. The biorenewable feedstock 112 may be pretreated to remove contaminants as well known in the art.

The untreated, diesel boiling range petroleum distillate feedstock 102 and the biorenewable feedstock 112 are brought together as combined feed 131, for example using a suitable mixing apparatus. In some embodiments, the amount of sulfur in the untreated, diesel boiling range petroleum distillate feedstock that is combined to form stream 131 is controlled to maintain at least about 150 wt. ppm sulfur in the combined feed 131, such as at least about 500 wt. ppm sulfur. The amount of sulfur introduced can be controlled by controlling the ratio of the untreated, diesel boiling range petroleum distillate feedstock to biorenewable feedstock. If more sulfur is needed, the ratio of the untreated, diesel boiling range petroleum distillate feedstock to biorenewable feedstock is increased. The exact ratio of the components of the combined feed 131 will depend therefore on the target sulfur levels, as well as the sulfur content of the untreated, diesel boiling range petroleum distillate feedstock 102. Thus, for example, in order to introduce 1500 ppm sulfur into the combined feed 131, a requisite amount of sulfur is needed from the petroleum distillate feedstock 102. If the biorenewable feedstock 112 has, for example, no sulfur and the untreated, diesel boiling range petroleum distillate feedstock has 15000 ppm sulfur, a ratio of about 10% petroleum distillate feedstock to about 90% biorenewable feedstock would introduce 1500 ppm sulfur in the treating reactor. A combined feed 131 comprising 1% petroleum distillate feedstock is unlikely to supply the required amount of sulfur for maintaining at least about 150 ppm sulfur in the combined feed. If a high percentage of biorenewable feedstock is to be processed, and the concentration of sulfur in the untreated, diesel boiling range petroleum distillate feedstock 102 is too low, it may be necessary to use a supplemental source of sulfur. For example, additional sulfur may be added to combined stream 131.

The combined feedstock 131 flows via a distillate charge pump 105 and pump 116 to a distillate gas exchanger 106 where it is heated. The combined feedstock 131 is then additionally heated in a distillate heater 107 with hydrogen gas. In an embodiment, the hydrogen gas comprises fresh hydrogen gas 120, usually made by reforming a natural gas. The fresh hydrogen gas is compressed in a fresh hydrogen gas compressor 126 to form compressed fresh hydrogen gas 127.

Biorenewable feedstocks and untreated distillate feedstocks typically contain contaminants such as alkali metals, e.g. sodium and potassium, phosphorous, as well as solids, water and detergents. Although the combined feedstock 131 may be processed without any prior treatments, the feedstock may be pretreated in order to remove as much of these contaminants as possible. One suitable means of removing metal contaminants from the feedstock is through the use of a guard bed 108, which is well known in the art. Guard bed 108 may include alumina guard beds either with or without demetallization catalysts such as nickel or cobalt. Guard bed 108 produces a purified, combined feedstock 142, which flows to a deoxygenation reactor, as described below.

The process continues by contacting the purified, combined feed 142 in a deoxygenation reactor 118 with a deoxygenation catalyst under reaction conditions to provide a reaction product 132. In the deoxygenation reactor 118, the purified, combined feed 142 is contacted with a deoxygenation catalyst at the reaction conditions to hydrogenate the olefinic or unsaturated portions of the n-paraffinic chains in the feedstock. Deoxygenation catalysts and reaction conditions are well known in the art. The deoxygenation catalysts are also capable of catalyzing decarboxylation and/or hydrodeoxygenation of the feedstock to remove oxygen therefrom. Decarboxylation and hydrodeoxygenation are herein collectively referred to as deoxygenation reactions. Hydrogen sulfide (H₂S) is produced from the sulfur species upon processing in the deoxygenation reactor 118 and, in the purified, combined stream 142, sulfides the deoxygenation catalyst. As a result, the deoxygenation catalyst is sulfided, maintaining catalyst performance, in accordance with an exemplary embodiment.

Deoxygenation catalysts suitable for use herein may include nickel or nickel/molybdenum dispersed on a high surface area support. Other suitable catalysts include one or more noble metal catalytic elements dispersed on a high surface area support. Non-limiting examples of noble metals include Pt and/or Pd dispersed on gamma-alumina. Deoxygenation conditions include a relatively low pressure of about 3447 kPa (500 psia) to about 6895 kPa (1000 psia), a temperature of about 200° C. to about 400° C. and a liquid hourly space velocity of about 0.5 to about 10 hr⁻¹. Because deoxygenation is an exothermic reaction, as the purified, combined feedstock 142 flows through the catalyst bed the temperature increases.

Of particular note with regard to the deoxygenation reactor 118 in the FIGURE is the lack of a recycle system associated therewith. In the prior art, it was typically necessary to include a relative high product recycle fraction into the deoxygenation reactor in order to maintain the catalyst activity therein by recycling H₂S in order to reduce the amount of external sulfiding agent input. This recycle fraction diluted the fresh feed, and thus decreased reactor throughput. In accordance with exemplary described embodiments however, the untreated, diesel boiling range petroleum distillate feedstock supplies the necessary sulfur. Therefore, a recycle stream/system is not required. Accordingly, the illustrated deoxygenation reactor is a “once-through” or “single-pass” reactor that does not include a product recycle stream.

The reaction product 132 from the deoxygenation reactor 118 includes a liquid fraction and a gaseous fraction. The two-phase reaction product 132 may be cooled in a suitable heat exchanger 128 to produce cooled reactor effluent 147 that is separated in a cold separator 162 into liquid fraction 148 and gaseous fraction 168. In an exemplary embodiment, the cooled reactor effluent stream 147 enters the cold separator 162, where a liquid water phase present at temperatures below the water dew point is separated from cold product liquid. The water is withdrawn and sent to a sour water stripper (not shown). The liquid fraction includes a blend of hydrocarbons (substantially all n-paraffins) from the biorenewable feedstock and the untreated, diesel boiling range petroleum feedstock that contains iso/normal paraffins, naphthenes, and aromatics. The higher the amount of biorenewable feedstock in the combined feed 131, the higher the cetane number and the worse the cold flow properties of the liquid fraction.

In accordance with an exemplary embodiment, the liquid fraction 148 may optionally be isomerized in an isomerization reactor 134 to form an isomerization product 136. In embodiments where the liquid fraction 148 is to be isomerized, the amount of nitrogen species in liquid fraction 148 should be controlled to 50 ppb by weight or less. Hence, the amount of nitrogen in the untreated diesel feed should be controlled such that, after passing through the deoxygenation reaction, the amount of nitrogen species in the liquid fraction 148 is at 50 ppb by weight or less. As is known in the art, the nitrogen may be substantially present in the form of organic nitrogen compounds such as non-basic aromatic compounds including carbazoles. The separated liquid fraction 148 from the cold separator 162 may be introduced, with fresh hydrogen gas 127, into the isomerization reactor 134 as stream 149. Stream 149 is processed under known isomerization conditions using a known isomerization catalyst to at least partially isomerize the n-paraffins therein into iso-paraffins to produce the isomerization product 136. The isomerization product 136 is introduced into an isomerization separator 135 for separation into a vapor stream 137 that includes hydrogen gas (which, although not shown, may optionally be recycled and combined with stream 120) and a hydrocarbon liquid stream 138 that is sent to a fractionation unit (not shown) to produce a green diesel blended fuel. Suitable operating conditions of the isomerization separator 135 include independently, for example, a temperature of about 200 to about 250° C. and a pressure of about 3500 to about 4500 kPa absolute. The liquid stream 138 is a branched-paraffin-rich stream. By the term “rich” it is meant that the effluent stream has a greater concentration of branched paraffins than the stream entering the isomerization reactor 134. As shown in the FIGURE, the isomerization reactor 134 may also be a single-pass or once-through type reactor that does not include a product recycling means.

The isomerization may be accomplished in any manner known in the art or by using any suitable catalyst known in the art. One or more beds of catalyst may be used. Fixed bed, trickle bed down flow, or fixed bed liquid filled up-flow modes are suitable. Suitable catalysts include a metal of Group VIII (IUPAC 8-10) of the Periodic Table and a support material. Suitable Group VIII metals include platinum and palladium, each of which may be used alone or in combination. The support material may be amorphous or crystalline. Suitable support materials include amorphous alumina, amorphous silica-alumina, ferrierite, ALPO-31, SAPO-11, SAPO-31, SAPO-37, SAPO-41, SM-3, MgAPSO-31, FU-9, NU-10, NU-23, ZSM-12, ZSM-22, ZSM-23, ZSM-35, ZSM-48, ZSM-50, ZSM-57, MeAPO-11, MeAPO-31, MeAPO-41, MeAPSO-11, MeAPSO-31, MeAPSO-41, MeAPSO-46, ELAPO-11, ELAPO-31, ELAPO-41, ELAPSO-11, ELAPSO-31, ELAPSO-41, laumontite, cancrinite, offretite, hydrogen form of stillbite, magnesium or calcium form of mordenite, and magnesium or calcium form of partheite, each of which may be used alone or in combination. Many natural zeolites, such as ferrierite, that have an initially reduced pore size can be converted to forms suitable for olefin skeletal isomerization by removing associated alkali metal or alkaline earth metal by ammonium ion exchange and calcination to produce the substantially hydrogen form. The isomerization catalyst may also include a modifier selected from lanthanum, cerium, praseodymium, neodymium, samarium, gadolinium, terbium, and mixtures thereof. Other suitable support materials include ZSM-22, ZSM-23, and ZSM-35.

The isomerization catalyst may be any of those well known in the art such as those described and cited above. Exemplary isomerization conditions include, independently, a temperature of about 150° C. to about 360° C. and a pressure of about 1724 kPa absolute (250 psia) to about 4726 kPa absolute (700 psia). In another embodiment the isomerization conditions include, independently, a temperature of about 300° C. to about 360° C. and a pressure of about 3102 kPa absolute (450 psia) to about 3792 kPa absolute (550 psia). Other operating conditions for the isomerization zone are well known in the art.

The liquid stream 138 contains hydrocarbons useful as diesel boiling range fuel as well as smaller amounts of naphtha and LPG. The liquid stream 138 may be recovered as diesel boiling range fuel or may be further purified in a product recovery column (not shown) that separates lower boiling components and dissolved gases from the diesel product containing C8 to C24 normal and mono-branched alkanes. Suitable operating conditions of the product recovery column include, independently, a temperature of from about 20 to about 200° C. at the overhead and a pressure from about 0 to about 1379 kPa absolute (0 to 200 psia).

Referring again to the FIGURE, the gaseous fraction 168 is withdrawn from the cold separator 162. An exemplary gaseous fraction 168 from the cold separator 162 includes unreacted hydrogen, dilute H₂S, carbon dioxide from the decarboxylation reaction in the treating reactor, carbon monoxide (CO), and the propane and other light hydrocarbons that are generated during the process. The gaseous fraction is treated in a recycle gas scrubber 170 to at least partially remove the carbon dioxide (CO₂) to produce a hydrogen gas, which in some embodiments could be recycled and used as part of stream 120, and the other light hydrocarbons as stream 110. The carbon dioxide can be removed by means well known in the art such as absorption with an amine, reaction with a hot carbonate solution, pressure swing absorption, etc. The recycle gas scrubber 170 also removes the dilute H₂S from the gaseous stream.

Accordingly, a method for processing a biorenewable feedstock has been provided. From the foregoing, it is to be appreciated that the exemplary embodiments of the method sulfide the deoxygenation catalyst helping to maintain its performance and reduce or substantially eliminate the amount of external sulfiding agent required by introducing an untreated, diesel boiling range petroleum distillate feedstock into the biorenewable feedstock. The exemplary embodiments further eliminate or reduce the need for a product recycle system associated with the deoxygenation reactor, thereby reducing operation costs and increasing throughput.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the claimed subject matter in any way. Rather, the foregoing detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for processing a biorenewable feedstock comprising the steps of:
combining an untreated, diesel boiling range petroleum distillate feedstock comprising sulfur with the biorenewable feedstock to form a combined feedstock; and
contacting the combined feedstock with a deoxygenation catalyst in the presence of hydrogen gas to form a deoxygenated, biorenewable product.

2. The method of claim 1, wherein the step of combining comprises combining sufficient untreated, diesel boiling range petroleum distillate feedstock with the biorenewable feedstock to form a combined feedstock comprising at least about 150 wt. ppm sulfur.

3. The method of claim 2, wherein the step of combining comprises combining sufficient untreated, diesel boiling range petroleum distillate feedstock with the biorenewable feedstock to form a combined feedstock comprising at least about 500 wt. ppm sulfur.

4. The method of claim 1, further comprising the step of passing the combined feedstock through a guard bed prior to the step of contacting.

5. The method of claim 1, wherein the step of contacting is performed in a single-pass or once-through manner.

6. The method of claim 1, further comprising the step of contacting the deoxygenated, biorenewable product with an isomerization catalyst in the presence of hydrogen gas to form an isomerized, biorenewable product.

7. The method of claim 6, wherein the step of contacting the deoxygenated, biorenewable product with the isomerization catalyst comprises contacting a deoxygenated, biorenewable product comprising less than or equal to about 50 wt. ppb nitrogen.

8. The method of claim 1, wherein the step of combining comprises combining the untreated, diesel boiling range petroleum distillate feedstock with a biorenewable feedstock that comprises free fatty acid and tri-glyceride species.

9. The method of claim 1, wherein the step of combining the biorenewable feedstock comprises combining a feedstock comprising one or more of vegetable oils, animal fats, and second generation oils.

10. An apparatus for processing a biorenewable feedstock comprising:
a first feedstock source comprising an untreated, diesel boiling range petroleum distillate feedstock comprising sulfur and nitrogen and a second feedstock source comprising the biorenewable feedstock;
a combining means that combines the untreated, diesel boiling range petroleum distillate feedstock with the biorenewable feedstock to form a combined feedstock; and
a deoxygenation reactor that contacts the combined feedstock with a deoxygenation catalyst in the presence of hydrogen gas to form a deoxygenated, biorenewable product.

11. The apparatus of claim 10, wherein the biorenewable feedstock comprises free fatty acid and tri-glyceride species, and wherein the combined feedstock comprises sufficient untreated, diesel boiling range petroleum distillate feedstock to form a combined feedstock comprising at least about 150 wt. ppm sulfur.

12. The apparatus of claim 11, wherein the combined feedstock comprises sufficient untreated, diesel boiling range petroleum distillate feedstock to form a combined feedstock comprising at least about 500 wt. ppm sulfur.

13. The apparatus of claim 10, further comprising a guard bed that purifies the combined feedstock upstream of the deoxygenation reactor.

14. The apparatus of claim 10, wherein the reactor is a single-pass or once-through reactor.

15. The apparatus of claim 10, further comprising an isomerization reactor that contacts the deoxygenated, biorenewable product with an isomerization catalyst in the presence of hydrogen gas to form an isomerized, biorenewable product.

16. The apparatus of claim 15, where the deoxygenated, biorenewable product that is contacted with the isomerization catalyst comprises less than or equal to about 50 wt. ppb nitrogen.

17. The apparatus of claim 10, wherein the second feedstock source comprises a biorenewable feedstock comprising one or more of vegetable oils, animal fats, and second generation oils.

18. A process for producing a biorenewable diesel boiling range product comprising the steps of:
combining an untreated, diesel boiling range petroleum distillate feedstock comprising sulfur and nitrogen with the biorenewable feedstock comprising free fatty acids and tri-glycerides to form a combined feedstock comprising at least about 150 wt. ppm sulfur;
purifying the combined feedstock in a guard bed to form a purified, combined feedstock;
contacting the purified, combined feedstock with a deoxygenation catalyst in a single-pass or once-through deoxygenation reactor in the presence of hydrogen gas to form a deoxygenated, biorenewable product; and
contacting the deoxygenated, biorenewable product with an isomerization catalyst in an isomerization reactor in the presence of hydrogen gas to form an isomerized, biorenewable product, wherein the deoxygenated, biorenewable product comprises less than or equal to 50 wt. ppb nitrogen.

19. The method of claim 18, wherein combining the untreated, diesel boiling range petroleum distillate feedstock with the biorenewable feedstock comprises forming a combined feedstock comprising at least about 500 wt. ppm sulfur.

20. The method of claim 18, wherein the step of combining the biorenewable feedstock comprises combining a feedstock comprising one or more of vegetable oils, animal fats, and second generation oils.
